(19) United States
(12) Patent Application Publication
(10) Pub. No.: US 2004/0047337 A1
(43) Pub. Date: Mar. 11, 2004

(54) Manager posts shortlist based on contingency

(76) Inventor: Fabien Marcel Jacques Guillorit, Eindhoven (NL)

Correspondence Address: U.S. Philips Corporation, 580 White Plains Road, Tarrytown, NY, 10591, US

(21) Appl. No.: 10/201,665

(22) Filed: Jul. 23, 2002

(30) Foreign Application Priority Data
Jul. 27, 2001 (EP) 01202871.8

(51) Int. Cl. H04J 1/16

(52) U.S. Cl. 370/352; 370/257

(57) ABSTRACT

For controlling a multi-station bus-based network to resume operating after a bus reset, first in each applicable station, a bus reset signalization is detected. Next, each applicable station undertakes to act as a configuration management server. Then, the configuration management server acquires in an initial cycle a preliminary list of all station node ID's as based on one or more contingency variables and the preliminary list is posted on the bus. Finally, in one or more further following cycles the one or more contingency variables are successively relaxed and extended versions of the list are posted.

The invention relates to a method for controlling a multi-station network, to resume operating after a bus reset according to the preamble of claim 1. One common cause for the occurring of such resets, in particular in networks used in relatively uncontrolled environments such as private households, is the adding or removing of a node or station. Indeed, a particular embodiment such as an IEEE 1394 and HAVi standardized network is often used for effecting various audio/video functionalities in a private household. The stations will then represent various device types, such as tuners, players, television sets, settop boxes, and the like, and the adding, moving, removing, or substituting of the various devices is commonplace, and which will then cause a bus reset.

Before resuming operations after the reset, all devices should check the various node ID's and GUID's and other key information, inasmuch these informations could have been changed. Now, a particular network configuration could comprises a wide range of station capabilities: stations may range from high-speed state of the art digital processors to slow electrical or electromechanical devices, where the proper operating could depend on some mechanical spin-up delay or the like. The inventor has recognized that in many cases a skeleton network configuration could resume operating after a brief delay for effectively rendering a subset of all network functions that would nevertheless be highly useful. If a device were not accessible during this phase, it could be ignored. On the other hand, the complete intended function of the network could in general not be attained with the leaving out of any of the various stations at all. Waiting for the slowest node or station to respond could mean to necessitate an appropriately long interval. Moreover, such slow device could even have been removed, and it such case, it would indeed never respond at all.

In consequence, amongst other things, it is an object of the present invention to let a configuration management server list all active devices by their node ID, their GUID, and such additional information as appropriate. Another object of the invention is to allow the network to resume operation within a relatively brief delay, whilst on the other hand providing that slow devices would not be left behind unable to join the network. A further advantage would be that single-manufacturer devices are relieved from the burden of rediscovering the whole network setup, so that they could focus their attention to stations from another manufacturer that might only partly conform to the standards applied by the first single manufacturer in question. The relieving from the above necessity will also diminish the bus traffic, so that effectively, the network bandwidth is raised. A final advantage of the present invention is that the mechanism of the present invention does not cause any inappropriate overhead to the configuration manager server, as compared to a situation wherein all stations would have to take part in the rediscovery operation. Also, a specific memory range can be allocated for this setting-up purpose, so that also devices with less than full HAVi functionality will be able to take part.

Now therefore, according to one of its aspects the invention is characterized according to the characterizing part of claim 1. The contingency variables could represent one or more preset delay values or a particular number of responding stations, or a combination thereof. The particular number could represent a particular fraction of the number of stations present in the situation before the reset occurring. Another criterium could be that the list of the responding stations would be enough to help devices to restore pre-existing communications and streams with each other.

The invention also relates to a system being arranged to implement a method as claimed in claim 1, and to a station being arranged to operate in a system as claimed in claim 8. Further advantageous aspects of the invention are recited in dependent claims.

These and further aspects and advantages of the invention will be discussed more in detail hereinafter with reference to the disclosure of preferred embodiments, and in particular with reference to the appended Figures that show:

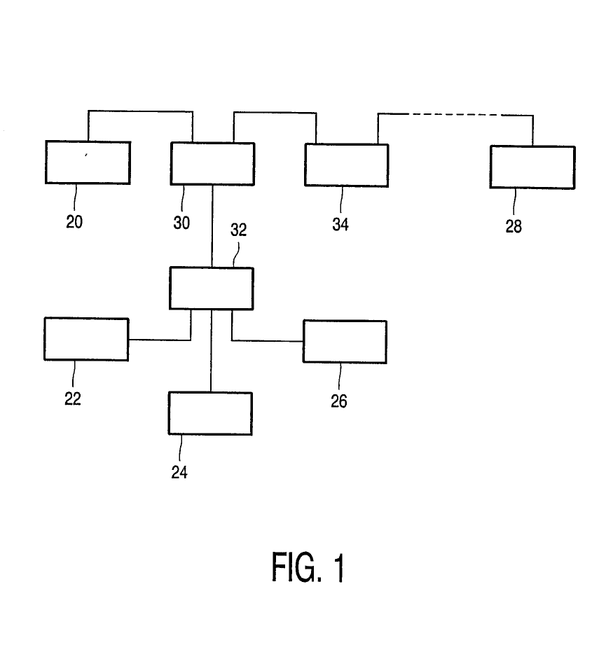

FIG. 1, a prior art network configuration according to the IEEE 1394 standard;

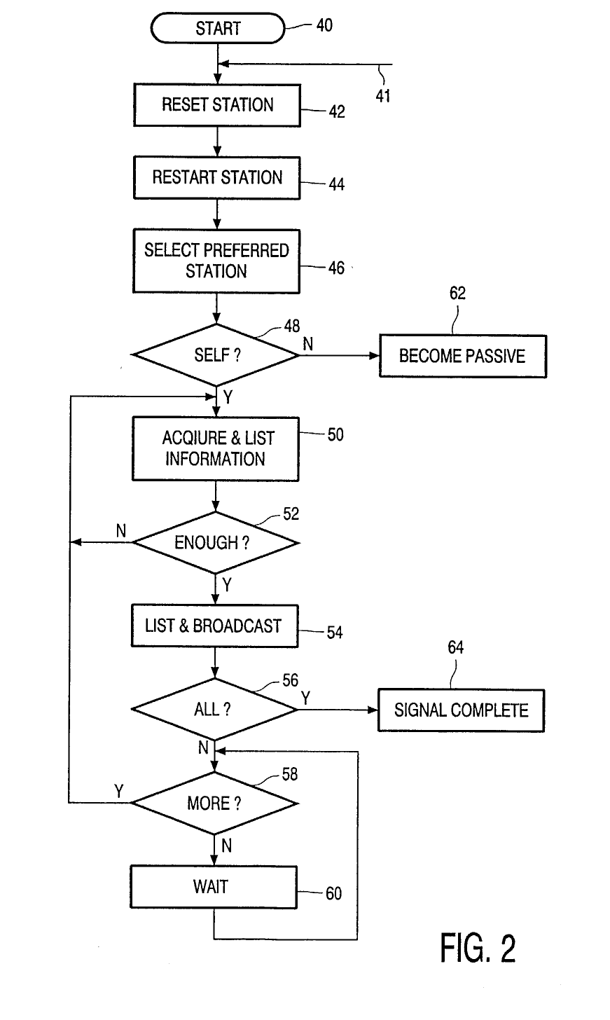

FIG. 2, a flow chart of a listing procedure according to the present invention.

FIG. 1 illustrates a prior art network configuration according to the IEEE 1394 standard, comprising singular connected stations or nodes 20, 22, 26, 28 and multiple connected nodes 30, 32, 34. In particular, reference is had to European Patent Application EP 0 933 900 A2, herein so incorporated. The reference in particular discloses a bridge facility for the particular network protocol. For the remainder the skilled art person will be aware of many sources for information on this protocol, so that further discussion is omitted for the sake of brevity. The present invention may however be practiced under various other bus protocols.

FIG. 2 illustrates a flow chart of a listing procedure according to the present invention as executed in a particular station. Of course, in a bus organization, the various stations will each operate in parallel along similar lines. In block 40, the procedure commences by claiming as far as necessary, hardware and software facilities. In block 42, a network reset condition is detected, which step as indicated by arrow 41 may be activated through another station not shown. In block 42, the station is furthermore actually reset. Next, the station is restarted in block 44. In particular, it will set aside a particular specific memory range. If the station in question has the ability to act as a configuration management server, it will try to effectively become one. Generally, various stations in parallel may be provided with the necessary facilities for this purpose. This trying may be effected in a similar manner as is commonly used to determine an acting bus master. In general, this is effected in that the contending stations will each send particular signalization patterns, on which patterns the bus will effect some logic function, such as an OR-function, or the like. The final outcome of the logic function can be detected in each station, and the resulting pattern will immediately point to the winner station. Generally although not necessarily, such will be the most powerful among the contending stations. For brevity, such is not explained in more detail here. Note that the configuration management server could be a different station from the one acting as such before the reset: the latter could have been removed or replaced, and/or the new configuration management server could have been freshly connected to the system.

In block 48, each applicable station detects whether it is itself the preferred station. If not, it will in block 62 become passive. Such a passive station would thereupon communicate the necessary informations exclusively with the configuration management server, until the latter would post the list of informations from which the passive station could again know the network configuration and if applicable and possible, resume a communication operation or pattern that existed before the reset signalization that started the procedure according to the present invention. For brevity, the operations by the passive station(s) until the receiving of the configuration management server's list have not been discussed further. The same applies to stations that lack the facility to act as a configuration management server. It has been understood that at least one station could act as a configuration managment server. Otherwise, the system would remain stalled.

In block 50, the actual configuration management server station will acquire and list the information regarding the network. In block 52, it will judge whether the requirement to the applicable contingency variable or variables will have been met, such as a preset time delay, or a number of station signalizations will have been acquired, or a combination thereof. If not yet, a waiting loop goes back to block 50. If positive in block 52, the configuration management server station will set up a list of the information acquired and broadcast it to the other stations. In block 56, the configuration management server station will judge whether all stations on the network have sent their information. If negative, the configuration management server station will go to blocks 58 and 60 that effectively constitute a waiting loop for the still remaining stations. If they will give signs of life or if another relaxing of the applicable contingency variables is applied, the list (block 50) will get extented, until eventually, the system will signal completion in block 64. If applicable, the completion may take an infinitely long time, because there may be silent stations.

For brevity, various further aspects have been ignored, such as the occurrence of a further reset condition during the execution of the flow chart. In this context, persons skilled in the art will recognize various changes and amendments that should be construed to form part of the present invention, unless they would exceed the scope of the appended claims.

1. A method for controlling a multi-station bus-based network to resume operating after a bus reset, said method being characterized by the steps of:
in each applicable station, detecting a bus reset signalization;
in each applicable station, undertaking to act as a configuration management server;
in said configuration management server, acquiring in an initial cycle a preliminary list of all station node ID's as based on one or more contingency variables and posting said preliminary list on the bus;
and in one or more further following cycles successively relaxing said one or more contingency variables and posting extended versions of said list.

2. A method as claimed in claim 1, wherein said acting as a configuration management server is based on an eventual outcome of an election procedure through exchanging of bus signalizations among plural stations.

3. A method as claimed in claim 1, wherein a most powerful station will act as configuration management server.

4. A method as claimed in claim 1, wherein said contingency variables include one of a time lapse and a number of station node's IDs received, or a combination thereof.

5. A method as claimed in claim 1, wherein said posting includes a request to a specific memory range applicable to the station in question.

6. A method as claimed in claim 5, wherein stations will monitor said specific memory range and will wait for the list from the configuration management server.

7. A method as claimed in claim 1, wherein said stations include both HAVi and non-HAVi-stations.

8. A system being arranged for implementing a method as claimed in claim 1 for controlling a multi-station bus-based network to resume operating after a bus reset, said system being characterized by comprising:
in each applicable station, detecting means for detecting a bus reset signalization;
in each applicable station, control means being arranged for undertaking to act as a configuration management server;
in said configuration management server, data processing means for acquiring in an initial cycle a preliminary list of all station node ID's as based on one or more contingency variables and posting said preliminary list on the bus;
and relax means for in one or more further following cycles successively relaxing said one or more contingency variables and posting extended versions of said list.

9. A system as claimed in claim 8, and being based on an IEEE 1394 bus protocol.

10. A station being arranged for implementing a method as claimed in claim 1 in a system as claimed in claim 8.

11. A station as claimed in claim 10, and being arranged to operate as a configuration management server.
